(19) United States
(12) Patent Application Publication
(10) Pub. No.: US 2003/0215244 A1
(43) Pub. Date: Nov. 20, 2003

(54) Optical communication system, signal relay apparatus and optical communication connector

(75) Inventors: Akira Norizuki, Shizuoka-ken (JP); Yoshikazu Saito, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/437,990

(22) Filed: May 15, 2003

(30) Foreign Application Priority Data
May 17, 2002 (JP) P 2002-143394
Mar. 7, 2003 (JP) P 2003-061983

(51) Int. Cl. H04B 10/00; H04B 10/02

(52) U.S. Cl. 398/175; 398/154

(57) ABSTRACT

In a first J/B 11 and a second J/B 12 in a vehicle, first photoelectric conversion sections 21 to 23 are disposed corresponding to respective electric apparatuses, a fourth photoelectric conversion section 24 is disposed to be connected to an optical transmission line, and first switch circuits 31 to 34 are disposed corresponding to the first photoelectric conversion sections 21 to 24, respectively. In these first J/B 11 and second 12, for example, if a break occurs in the optical transmission line which connects the first photoelectric conversion section 21 to the electric apparatus, a system is rebuilt, in which the first switch circuit 31 is closed to relay an electric signal by bypassing the first photoelectric conversion section 21.

### BACKGROUND OF THE INVENTION

1. Field of the Invention

The present invention relates to an optical communication system for interconnecting, through an optical transmission line, a plurality of electric apparatuses which are installed in a vehicle, and to a signal relay apparatus and an optical communication connector in this optical communication system.

2. Description of the Related Art

Conventionally, as a data transmission system for transmitting data in a vehicle, a system has been known, in which an optical fiber cable is provided in the vehicle and transmits non-time series data such as commands, or time series data such as video data by use of the optical fiber cable.

In the data transmission system, there is a synchronous ring-type network designed to transmit time series audio data, video data and the like. Through this synchronous ring-type network, data transmission is carried out by interconnecting communication apparatuses in a ring shape and synchronizing data transmission timing among the communication apparatuses.

As shown in FIG. 1, such a synchronous ring-type network is constituted in a manner that electric apparatuses A, B and C are arranged in the vicinity of a front seat in a vehicle front portion, an electric apparatus D is arranged in the vicinity of a rear seat, and further, electric apparatuses E and F are arranged in a trunk room of a vehicle rear portion. The electric apparatuses are interconnected in the ring shape through an optical transmission line 101 and optical connectors 102, and data is transmitted while an optical signal is being relayed in a given direction among the electric apparatuses.

However, in the conventional synchronous ring-type network, when a part of the optical transmission line 101 of the ring-shaped connection is broken, the transmission of the optical signal through this broken part becomes impossible to transmit. Thus, the network has had a problem of impossibility of maintaining communications in the entire system even if the optical transmission lines or electric apparatuses, which can be used, exist in part of the network.

### SUMMARY OF THE INVENTION

The present invention is made in view of the foregoing problem, and an object of the invention is to provide an optical communication system, a signal relay apparatus and an optical communication connector which can maintain a communication by a simple process even if an optical communication line is broken.

To solve the problem described above, an optical communication system according to the present invention is constituted as follows. A plurality of photoelectric conversion means, which are disposed corresponding to the electric apparatuses in a plurality of signal relay apparatuses, convert an optical signal entered from each of the corresponding electric apparatuses into an electric signal to output the electric signal to another photoelectric conversion means, and convert an electric signal entered from the other photoelectric conversion means into an optical signal to output the optical signal to the corresponding electric apparatus. Further, a plurality of switch circuits, which are disposed in electric signal input/output terminals of the photoelectric conversion means, opens/closes to bypass an electric signal from the adjacent photoelectric conversion means.

In this optical communication system, the photoelectric conversion means determines a break in the optical transmission line between the electric apparatuses or between the electric apparatus and the other signal relay apparatus based on a status of an optical signal from the optical transmission line and controls opening/closing of each of the switch circuits to stop outputting of an optical signal to the broken transmission line. Thus, according to this optical communication system, a ring-shaped system is rebuilt by the other electric apparatuses by preventing the outputting of the optical signal to the electric apparatus connected to the broken optical transmission line.

In another optical communication system of the present invention, the signal relay apparatus includes signal monitoring means. The signal monitoring means detects a variation of the electric signal outputted from the photoelectric conversion means to the switch circuit and opens the switch circuit, and when there is a variation during over defined time, the signal monitoring means opens the switch circuit to allow the electric apparatus corresponding to the photoelectric conversion means to communicate with the other electric apparatus.

An signal relay apparatus according to the present invention is constituted as follows. A plurality of photoelectric conversion means, which are disposed corresponding to the electric apparatuses, convert an optical signal entered from each of the corresponding electric apparatuses into an electric signal to output the electric signal to other photoelectric conversion means and convert an electric signal entered from the other photoelectric conversion means into an optical signal to output the optical signal to the corresponding electric apparatus. Further, a plurality of switch circuits, which are disposed in electric signal input/output terminals of the photoelectric conversion means, open/close to bypass an electric signal from the adjacent photoelectric conversion means. Thus, it is possible to solve the problem described above.

In the signal relay apparatus, the photoelectric conversion means controls opening/closing of the switch circuit based on the status of the optical signal from the optical transmission line to stop outputting of the optical signal to the corresponding electric apparatus. Thus, according to this signal relay apparatus, a ring-shaped network is rebuilt by the other electric apparatuses by preventing outputting of the optical signal to the electric apparatus connected to the broken optical transmission line.

Another signal relay apparatus of the present invention includes signal monitoring means which controls opening/closing of the switch circuit. The signal monitoring means detects a variation of the electric signal outputted from the photoelectric conversion means to the switch circuit, and when there is a variation during over defined time, the signal monitoring means opens the switch circuit to allow the electric apparatus corresponding to the photoelectric conversion means to communicate with the other electric apparatus.

An optical communication connector according to the present invention is constituted as follows. First photoelectric conversion means which converts an optical signal entered from the optical transmission line into an electric signal to output the electric signal, and converts an entered electric signal into an optical signal to output the optical signal to the optical transmission line. Further, second photoelectric conversion means which converts an optical signal entered from the optical transmission line into an electric signal to output the electric signal to the first photoelectric conversion means, and converts an electric signal entered from the first photoelectric conversion means into an optical signal to output the optical signal to the optical transmission line. Last, a switch circuit, which is disposed between the first and second photoelectric conversion means, bypasses an electric signal from the first or second photoelectric conversion means. Thus, it is possible to solve the problem described above.

In the optical communication connector, the first photoelectric conversion means controls opening/closing of the switch circuits based on the status of the optical signal from the optical transmission line to stop entry of the outputted electric signal to the second photoelectric conversion means, and the second photoelectric conversion means controls the opening/closing of the switch circuit based on the status of the optical signal from the optical transmission line to stop entry of the outputted electric signal to the first photoelectric conversion section. Thus, according to the optical communication connector, a ring-shaped system is rebuilt by the other electric apparatus by preventing outputting of the optical signal to the electric apparatus connected to the broken optical transmission line.

Another optical communication connector includes signal monitoring means which controls opening/closing of the switch circuit. The signal monitoring means detects a variation of the electric signal outputted from the first or second photoelectric conversion means to the switch circuit and opens the switch circuit when there is a variation during over defined time.

### BRIEF DESCRIPTION OF THE DRAWINGS

FIG. 1 is a block diagram showing a configuration of a conventional optical communication system.

FIG. 2 is a block diagram showing a configuration of an optical communication system according to a first embodiment of the present invention.

FIG. 3 is a block diagram showing constitutions of a first J/B and a second J/B of the present invention.

FIG. 4 is a block diagram showing a constitution of a photoelectric conversion section.

FIG. 5 is a time chart explaining an operation of the photoelectric conversion section: (a) showing a variation of an optical signal level, (b) showing a variation of an outputted electric signal, and (c) showing a variation of a status determination signal.

FIG. 6 is a view explaining a process of switching a status of a switch circuit by the photoelectric conversion section: (a) showing a variation of a status determination signal, and (b) showing a variation of a status of the switch circuit.

FIG. 7 is a block diagram showing another constitution of the J/B of the present invention.

FIG. 8 is a block diagram showing a constitution of an in-line connector of the present invention.

FIG. 9 is a block diagram showing circuitry incorporated in a J/B, an in-line connector or the like in an optical communication system according to a second embodiment of the present invention.

FIG. 10 is a timing chart which explains an operation in the optical communication system of the second embodiment of the present invention.

FIG. 11 is a flowchart mainly explaining an operation of a signal monitoring section in the optical communication system of the second embodiment of the present invention.

FIG. 12 is a time chart explaining a comparative example with respect to the optical communication system of the second embodiment of the present invention.

FIG. 13 is a time chart explaining another comparative example with respect to the optical communication system of the second embodiment of the present invention.

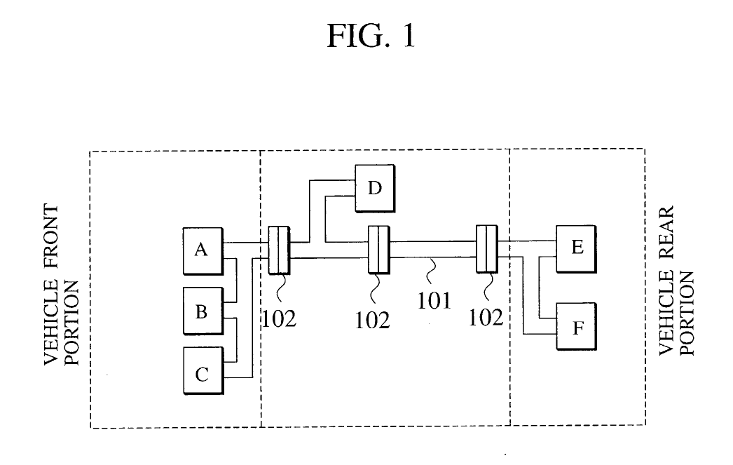

### DETAILED DESCRIPTION OF THE PREFERRED EMBODIMENT

Hereinafter, the first and second embodiments of the present invention will be described with reference to the accompanying drawings.

[First Embodiment]

[Configuration of Optical Communication System of the First Embodiment]

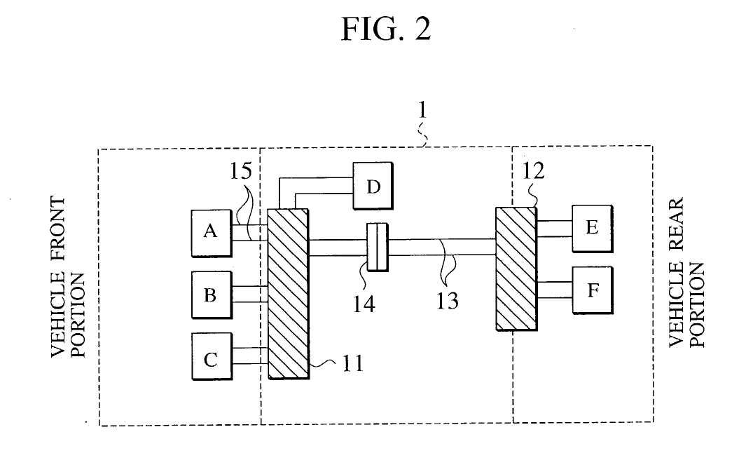

The present invention is applied to, for example, an optical communication system of the first embodiment configured as shown in FIG. 2. This optical communication system is configured by arranging electric apparatuses A, B and C in the vicinity of a front seat of a vehicle front portion, an electric apparatus D in the vicinity of a rear seat, and further electric apparatuses E and F in a trunk room of the vehicle rear portion. In a vehicle 1 on which the optical communication system is mounted, due to its interior structure and arrangement of electric wires, a first junction block (J/B) 11 is disposed to be limited in the vicinity between the front and rear seats, and a second J/B 12 is disposed to be limited in the vicinity between the rear seat and the trunk room.

A harness which integrates, for example, power lines for supplying power to other electric apparatuses not constituting the optical communication system, control lines for detecting or controlling statuses of the other electric apparatuses, in-line connectors or the like is connected to the first J/B 11 and the second J/B 12. Thus, the first J/B 11 and the second J/B 12 convert and supply power from a battery, and supply control signals to defined electric apparatuses.

The harness connected to the first J/B 11 and the second J/B includes an optical fiber cable which is an optical transmission line 13 constituting the optical communication system. This optical fiber cable is arranged to connect the first J/B 11 and the second J/B 12, and an in-line connector 14 is disposed in the optical transmission line 13 which connects the first J/B 11 and the second J/B 12. The first J/B 11, the second J/B 12, and the electric apparatuses A to F are connected by an electric transmission line 15.

In this optical communication system, the electric apparatuses are connected in a ring shape, and the electric apparatuses relay an optical signal among adjacent electric apparatuses in synchronization, whereby the optical signal is relayed in sequence of, for example, the electric apparatus A, the electric apparatus D, the electric apparatus E, the electric apparatus F, the electric apparatus C, the electric apparatus B, and the electric apparatus A. At this time, each of the electric apparatuses carries out a signal synchronizing process and the like in accordance with a communication protocol predefined by the optical communication system. Then, each of the electric apparatus adds an address of an electric apparatus of a destination to transmit the optical signal. Upon reception of the optical signal from the adjacent electric apparatus, each of the electric apparatuses receives the optical signal if the device itself is a destination, or relays the optical signal to the adjacent electric apparatus if the device itself is not a destination.

[First Constitutional Examples of First J/B 11 and Second J/B 12]

Next, first constitutional examples of the first J/B 11 and the second J/B 12 will be described. In the description, since the first J/B 11 and the second J/B 12 are similarly constituted, the first J/B 11 and the second J/B 12 are generically called “J/B”.

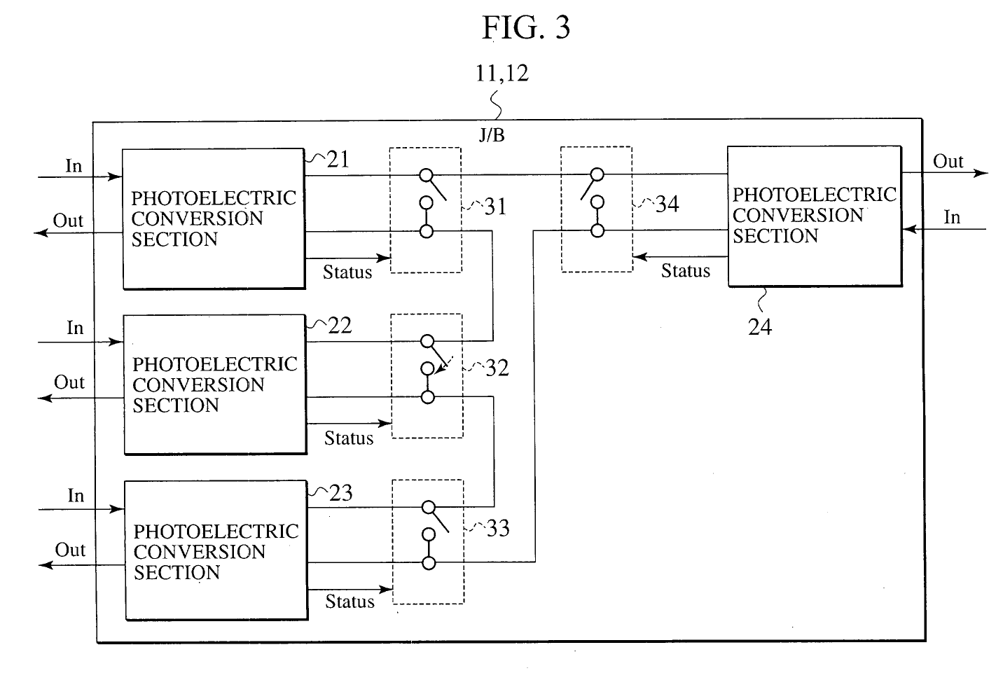

As shown in FIG. 3, the J/B includes a first photoelectric conversion section 21 connected through the optical transmission line 15 to the electric apparatus A, a second photoelectric conversion section 22 connected through the optical transmission line 15 to the electric apparatus B, a third photoelectric conversion section 23 connected through the optical transmission line 15 to the electric apparatus C, and a fourth photoelectric conversion section 24 connected through the optical transmission line 13 to the other J/Bs. In this J/B, the fourth and third photoelectric conversion sections 24 and 23 are electrically connected to each other, the third and second photoelectric conversion sections 23 and 22 are electrically connected to each other, the second and first photoelectric conversion sections 22 and 21 are electrically connected to each other, and the first and fourth photoelectric conversion sections 21 and 24 are electrically connected to each other.

In the J/B, the fourth photoelectric conversion section 4, the third photoelectric conversion section 23, the electric apparatus C, the second photoelectric conversion section 22, the electric apparatus B, and the first photoelectric conversion section 21 are connected in a ring shape. The J/B is constituted so that when the optical signal is entered to the fourth photoelectric conversion section 24, the signal can be relayed in sequence of the third photoelectric conversion section 23, the electric apparatus C, the third photoelectric conversion section 23, the second photoelectric conversion section 22, the electric apparatus B, the second photoelectric conversion section 22, the first photoelectric conversion section 21, the electric apparatus A, the first photoelectric conversion section 21, and the fourth photoelectric conversion section 24.

Additionally, the J/B includes first to fourth switch circuits 31 to 34 disposed in signal input/output sides of the photoelectric conversion sections 21 to 24, respectively. Each of these switch circuits 31 to 34 has a function of bypassing and relaying an electric signal from an adjacent photoelectric conversion section. Opening/closing operations of the first to fourth switch circuits 31 to 34 are controlled by status determination signals (status) from the corresponding first to fourth photoelectric conversion sections 21 to 24.

[Constitution of Photoelectric Conversion Section]

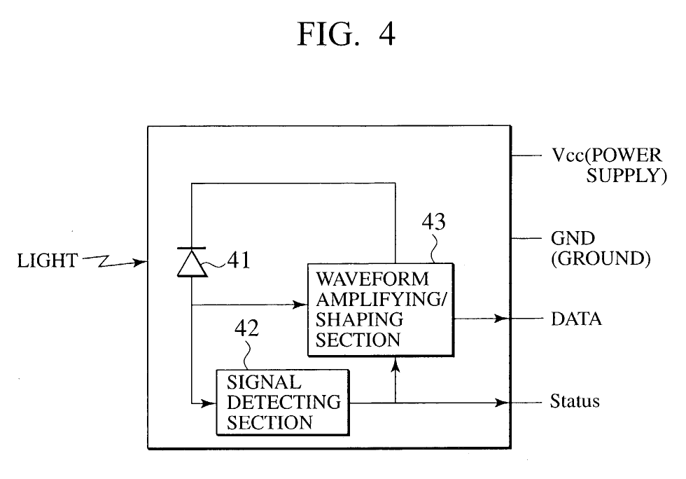

The first to fourth photoelectric conversion sections 21 to 24 are constituted as shown in FIG. 4. In the description below, the first to fourth photoelectric conversion sections 21 to 24 are generically called a “photoelectric conversion section”, and the first to fourth switch circuits 31 to 34 connected to the first to fourth photoelectric conversion sections 21 to 24, respectively, are generically called a “switch circuit”.

The photoelectric conversion section includes a light receiving section 41 for receiving the optical signal from the optical transmission line 13 or 15, a signal detecting section 42, and a waveform amplifying/shaping section 43. The photoelectric conversion section also includes a power supply terminal and a GND terminal which receive power supply Vcc through a battery and a power supply line, not shown, and then the photoelectric conversion section is driven.

Upon entry of the optical signal to the light receiving section 41, the photoelectric conversion section generates an electric signal, of which level is varied in accordance with a variation of an optical signal level, and outputs the electric signal to the waveform amplifying/shaping section 43. At this time, the signal detecting section 42 monitors the level of the optical signal received by the light receiving section 41, and determines entry of a normal optical signal to generate a status determination signal of a low (L) level if it is determined that a stable optical signal equal to/more than a predetermined level has been entered. On the other hand, if it is determined that no stable optical signals equal to/more than the predetermined level have been entered to the light receiving section 41, the signal detecting section 42 determines no entry of a normal optical signal to generate a status determination signal of a high (H) level. This status determination signal is sent to the waveform amplifying/shaping section 43 and the switch circuits 31 to 34.

Upon entry of the status determination signal of the L level, the waveform amplifying/shaping section 43 amplifies the electric signal generated by the light receiving section 41 to, for example, a preset electric signal level, shapes the electric signal, and outputs the electric signal to the adjacent photoelectric conversion section. On the other hand, upon entry of the status determination signal of the H level, the waveform amplifying/shaping section 43 does not output the electric signal entered from the light receiving section 41.

Specifically, in the photoelectric conversion section, as shown in FIG. 5, when the optical signal level from the optical transmission line 15 becomes equal to/more than a predetermined value at time t1 (FIG. 5 (a)), the status determination signal is turned from the H level to the L level (FIG. 5(c)), and the electric signal (DATA) generated by the light receiving section 41 starts to be outputted from the waveform amplifying/shaping section 43 is started (FIG. 5(b)). At this time, the switch circuit is turned from the closed state to the opened state to output the electric signal from the adjacent photoelectric conversion section to the electric apparatus, and the photoelectric conversion section converts the optical signal from the electric apparatus and output the optical signal to the other photoelectric conversion section.

Then, for example, when a break in the optical transmission line or the like occurs, and no entry of the optical signal equal to/more than the predetermined value to the light receiving section 41 is detected by the signal detecting section 42 at time t2 (FIG. 5(a)), the status determination signal is turned from the L level to the H level (FIG. 5(c)). Accordingly, the switch circuit is turned from the opened state to the closed state to bypass the entered electric signal.

Specifically, for example, if a break occurs in the optical transmission line 15 which connects the first photoelectric conversion section 21 to the electric apparatus A and the optical signal entered to the first photoelectric conversion section 21 does not reach the predetermined level, the status determination signal of the H level is supplied to the first switch circuit 31 to close the first switch circuit 31. As a result, the electric signal from the second photoelectric conversion section 22 is bypassed without being supplied to the first photoelectric conversion section 21 and the electric apparatus A to be supplied to the fourth photoelectric conversion section 24. Additionally, for example, if a break occurs in the optical transmission line 13 which connects the second J/B 12 to the first J/B 11 and the optical signal entered to the fourth photoelectric conversion section 24 does not reach the predetermined value, the status determination signal of the H level is supplied to the fourth switch circuit 34 to close the fourth switch circuit 34. As a result, the electric signal from the first photoelectric conversion section 21 is bypassed without being supplied to the fourth photoelectric conversion section 24 to be supplied to the third photoelectric conversion section 23.

According to the optical communication system including the first J/B 11 and the second J/B 12, even if a break occurs in the optical transmission line 15 which connects the first J/B 11 to the electric apparatus or the optical transmission line 13 which connects the first J/B 11 to the second J/B 12, a failure occurs in some of electric apparatuses, or a loose fitting of the in-line connector 14 occurs, it is possible to maintain communications by a simple process of controlling the opening/closing operation of the switch circuit. Even if a break occurs partially in the optical transmission line, the entire communications are not made impossible.

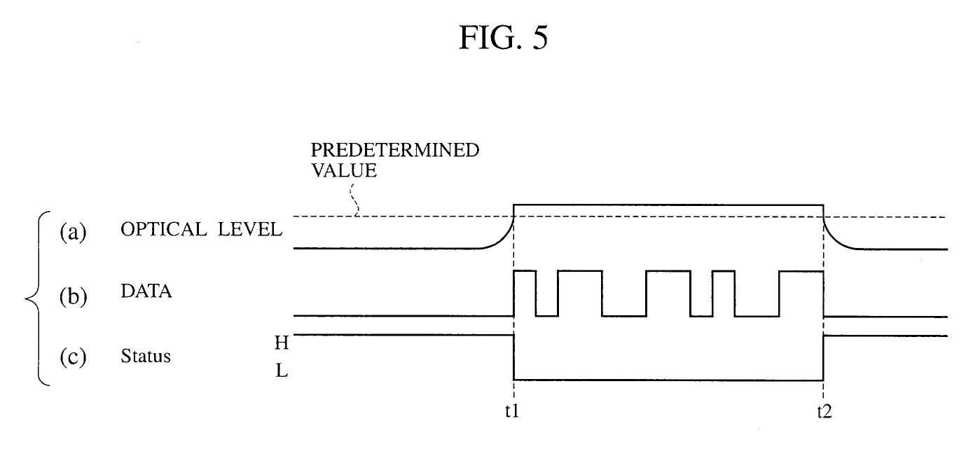

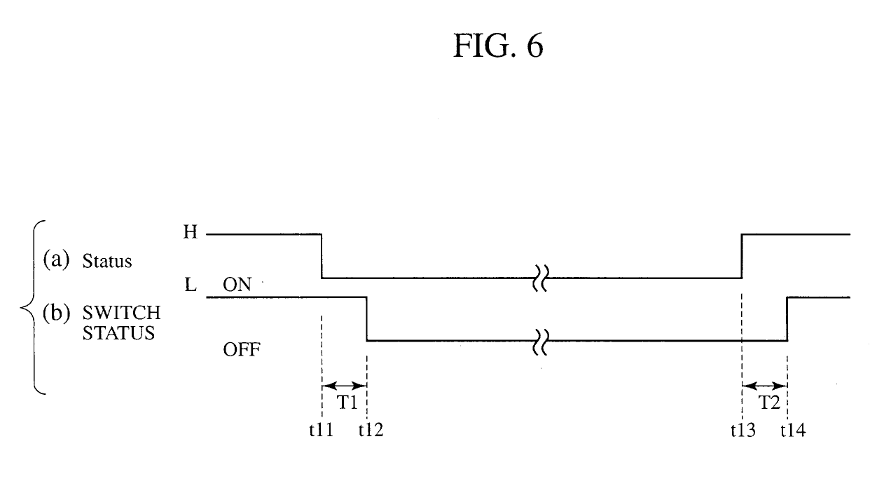

In the control of the opening/closing operation of the switch circuit, as shown in FIG. 6, when the status determination signal is turned from the H level to the L level to switch from the closed state to the opened state, or when the status determination signal is turned from the L level to the H level to switch from the opened state to the closed state, the signal detecting section 42 controls output timing of the status determination signal such that the status determination signal is outputted to the switch circuit in predetermined time after the status determination signal becomes stable. Specifically, as shown in FIG. 6(a), the signal detecting section 42 outputs the status determination signal to the switch circuit after the passage of predetermined period T1 from time t11 at which the optical signal level becomes equal to/more than the predetermined value at the light receiving section 41, and switches the switch circuit from the closed state ((ON) to the opened state (OFF) at time t12 (FIG. 6(b)). As shown in FIG. 6(a), the signal detecting section 42 outputs the status determination signal to the switch circuit after the passage of predetermine period T2 from time t13 at which the optical signal becomes equal to/less than the predetermined value at the light receiving section 41, and switches the switch circuit from the opened state (OFF) to the closed state (ON) at time t14 (FIG. 6(b)).

Thus, the opening/closing operation of the switch circuit is not carried out by the signal detecting section 42 by controlling the switching timing of the switch circuit even if the optical signal temporarily becomes equal to/more than the predetermined value, or equal to/less than the predetermined value. Therefore, according to the optical communication system, it is possible to carry out stable control without any erroneous determination of a break in the optical transmission line or the like.

[Second Constitutional Examples of First J/B and Second J/B]

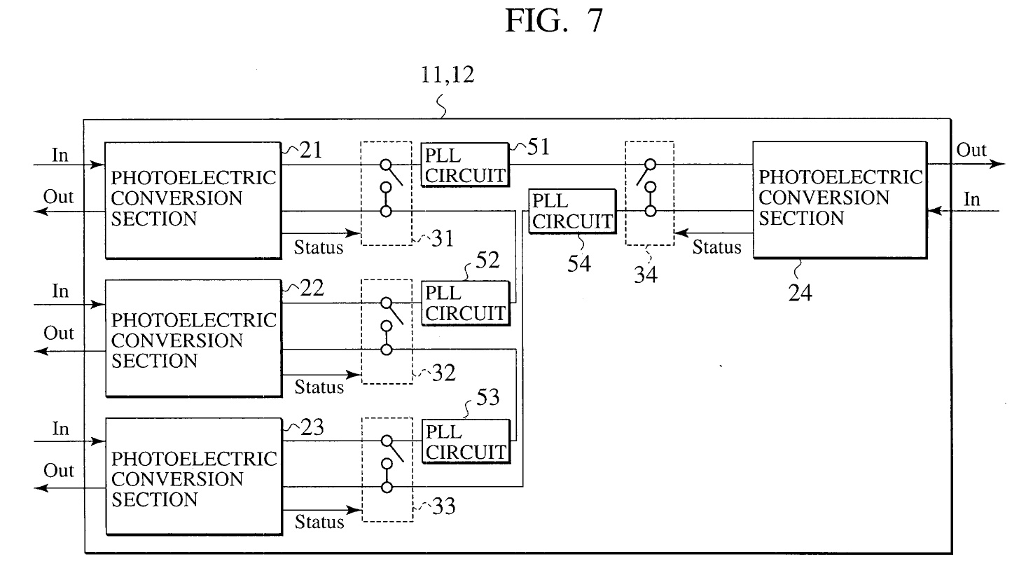

Next, second constitutional examples of the first J/B 11 and the second J/B 12 will be described by referring to FIG. 7. Components similar to those described above are denoted by similar reference numerals, and detailed description thereof will be omitted.

As shown in FIG. 7, the J/B of the second constitutional example includes phase locked loop (PLL) circuits 51 to 54 disposed in electric signal output terminals of the photoelectric conversion sections to synchronize the electric signal. Each of the PLL circuits 51 to 54 carries out a process similar to a synchronizing process carried out by a communication IC incorporated in the connected electric apparatus.

Upon entry of the electric signal, each of the PLL circuits 51 to 54 refers to its clock component, and outputs the electric signal to the adjacent photoelectric conversion section in synchronization with a predetermined clock component defined in the optical communication system. In such a JIB, for example, when a break in the optical transmission line 13 or 15, or a failure of the electric apparatus occurs, each of the PLL circuits 51 to 54 is controlled by a not-shown control unit so as to resynchronize the electric signal in the entire optical communication system.

According to the optical communication system, even if a break in the optical transmission line or the like occurs and the opening/closing operation of the switch circuit is controlled to rebuild a system configuration, the optical signal can be resynchronized by resynchronizing the electric signal by use of the PLL circuits 51 to 54.

[Constitution of In-Line Connector 14]

Next, description will be made of a constitution of the in-line connector 14 in the optical communication system.

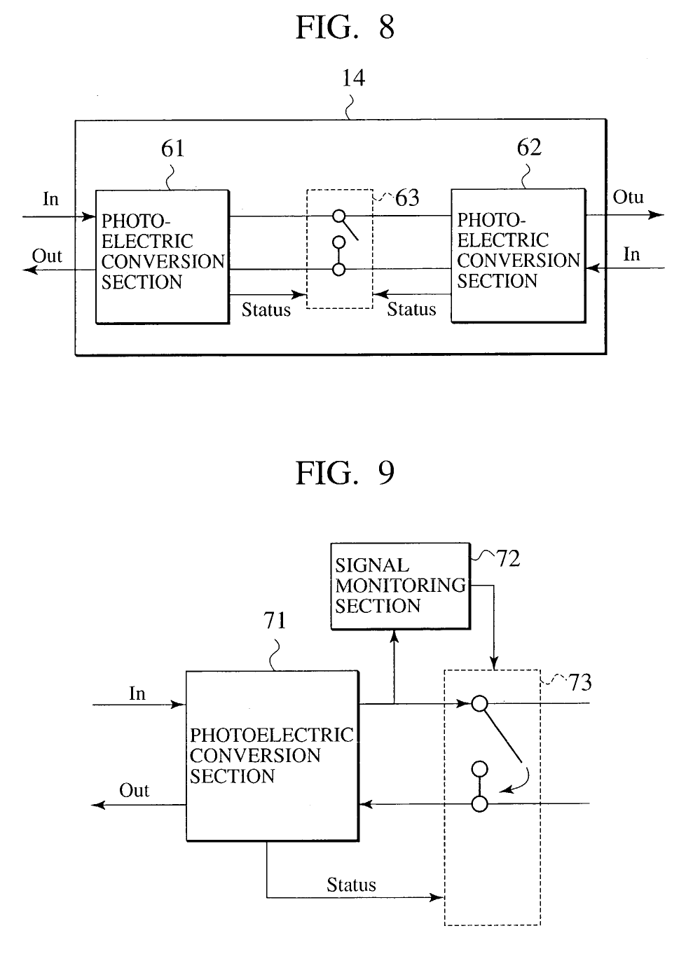

As shown in FIG. 8, the in-line connector 14 includes a fifth photoelectric conversion section 61 connected through the optical transmission line 13 to the first JIB 11, a sixth photoelectric conversion section 62 connected through the optical transmission line 13 to the second JIB 12, and a switch circuit 63 disposed between the fifth and sixth photoelectric conversion sections 61 and 62.

The fifth photoelectric conversion section 61 outputs a status determination signal of an H level to the switch circuit 63 when an optical signal level from the first J/B 11 is equal to/less than a predetermined value. The sixth photoelectric conversion section 62 outputs a status determination signal of an H level to the switch circuit 63 when an optical signal level from the second J/B 12 is equal to/less than a predetermined value. The switch circuit 63 is closed when the status determination signal of the H level is entered from the fifth or sixth photoelectric conversion section 61 or 62.

In this in-line connector 14, the closed state is set to enable configuration of an optical communication system including the electric apparatuses F, E, or an optical communication system including the electric apparatuses C, B, A, D.

Thus, the optical communication system can provide advantages similar to those described above.

The foregoing embodiment is an example of the present invention. Thus, the invention is not limited to the embodiment. It is obvious that, even in other embodiments, various changes can be made in accordance with design or the like without departing from the technical teachings of the invention.

Specifically, in the foregoing example, the switch circuits are disposed in the first J/B 11, the second J/B 12 and the in-line connector 14 to bypass the electric signal. Even if the switch circuit is disposed only in one of the first J/B 11, the second J/B 12 and the inline connector 14, advantages similar to the above can be provided.

In the example of FIG. 7, the PLL circuit is disposed in the electric signal output terminal of each of the photoelectric conversion sections. Other than this, disposition of a single PLL circuit between the switch circuits can provide advantages similar to the above.

[Second Embodiment]

Next, an optical communication system according to the second embodiment will be described. However, detailed description of portions similar to those of the first embodiment will be omitted.

In the foregoing J/B or in-line connector, the switch circuit is opened/closed by the status determination signal (Status) based on the level of the optical signal generated by the photoelectric conversion section to build the ring-shaped network. As shown in FIG. 9, the optical communication system of the second embodiment is characterized by connecting a signal monitoring section 72 to an electric signal output line of a photoelectric conversion section 71, and opening/closing a switch section 73 based on determination of the signal monitoring section 72.

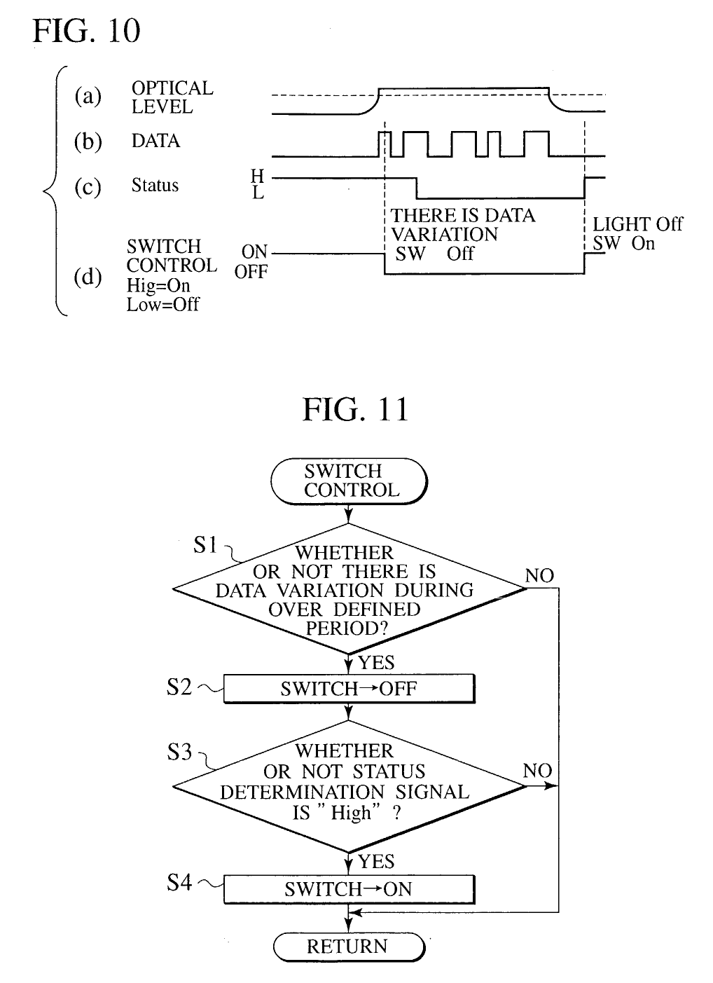

In the optical communication system, upon entry of an optical signal from the electric apparatus, the photoelectric conversion section 71 generates an electric signal similar to that shown in FIG. 10(b) in accordance with detection of a predetermined optical level as shown in FIG. 10(a) and sends the electric signal to the signal monitoring section 72. At this time, when the electric signal becomes equal to/more than the predetermined optical level, the photoelectric conversion section 71 sends a status determination signal similar to that of the foregoing embodiment to the switch section 73 as shown in FIG. 10(c).

On the other hand, upon reception of en electric signal shown in FIG. 10(b), the signal monitoring section 72 sends a control signal to the switch section 73 to open the switch section 73 at the time at which the electric signal rises as shown in FIG. 10(d).

As its process is shown in a flowchart of FIG. 11, the signal monitoring section 72 first determines whether or not there is data variation during over preset defined period in the received electric signal in step S1. For example, if there is no data variation during over the defined period even when an electric signal is entered, the signal monitoring section 72 determines that the electric signal is normal and finishes the process.

On the other hand, if the signal monitoring section 72 determines that there is a data variation during over the defined period, the signal monitoring section 72 determines that a normal optical signal has been supplied to the photoelectric conversion section 71 and a normal electric signal has been generated at the photoelectric conversion section 71. Then, the process proceeds to step S2 and the switch section 73 is opened (off). Thus, the signal monitoring section 72 builds a ring-shaped network including the electric apparatus connected to the photoelectric conversion section 71.

In next step S3, the photoelectric conversion section 71 generates a status determination signal of an H level to determine whether or not the switch section 73 is controlled to be closed, whereby it is determined whether or not a normal optical signal has been entered to the photoelectric conversion section 71. For example, if a break or the like occurs in the optical transmission line to prevent entry of a normal optical signal to the photoelectric conversion section 71, and a status determination signal is an H level, the switch section 73 is closed (on) in step S4 to build a ring-shaped network in which the electric apparatus connected to the photoelectric conversion section 71 is bypassed.

According to this optical communication system including the J/B and the in-line connector which include the signal monitoring section 72 and the switch section 73, a break in the transmission line can be determined by the electric signal as in the case of the first embodiment.

Also, according to this optical communication system, even when an abnormal optical signal is temporarily supplied to the photoelectric conversion section 71 by noise or the like to close the switch section 73, if the electric signal is monitored by the signal monitoring section 72 and when there are no more data variation during over the defined period, the ring-shaped network can be rebuilt.

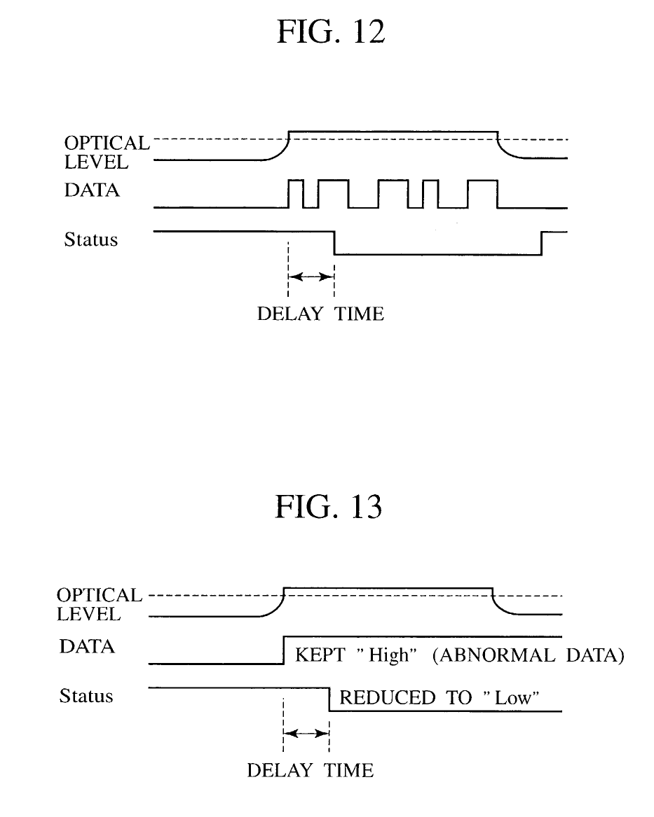

Additionally, according to this optical communication system, for example as shown in FIG. 12, even if the photoelectric conversion section 71 detects a predetermined optical level to output an electric signal, it is possible to prevent a situation where the switch section 73 cannot be controlled immediately by delay time, until which the status determination signal is outputted, and it is also to operate the switch section 73 without any delay time, thereby establishing a ring-shape network within a short time. Especially, when a plurality of electric apparatuses are used to establish the ring-shaped network at the time of starting up the system, the delay time of the plurality of photoelectric conversion sections can be eliminated, which makes it possible to greatly shorten the time of completing ring-shaped network establishment compared with the establishment of that based on the status determination signal.

According to this optical communication system, even if there is no entry of an optical signal, it is possible to prevent a malfunction of the switch section 73 caused by a problem of the photoelectric conversion section 71 such as opening of the switch section 73.

According to the optical communication system, by monitoring the electric signal, even when an abnormality such as an electric signal having a very long duration of H level outputted by the optical conversion, for example, due to a high temperature, as shown in FIG. 13, is entered to the switch section 73, it is possible to prevent a malfunction of opening the switch section 73 by use of the status determination signal in accordance with the level of an optical signal during over the defined period.

Furthermore, according to this optical communication system, the electric signal is first monitored by the signal monitoring section 72 at the time of starting up each electric apparatus, the electric apparatus is included in the ring-shaped network, and then the switch section 73 is controlled corresponding to a break in the ring-shaped network or the like by use of the status determination signal based on the level of the optical signal. Thus, the opening/closing of the switch section 73 can be controlled by use of both of the electric signal and the status determination signal to improve system reliability.

What is claimed is:

1. An optical communication system comprising:
a plurality of electric apparatuses interconnected in a ring shape, each of which relays an optical signal by use of an optical transmission line; and
a plurality of signal relay apparatuses, each of which includes a plurality of photoelectric conversion means for converting an optical signal entered from each of the corresponding electric apparatuses into an electric signal to output the electric signal to another photoelectric conversion means and converting an electric signal entered from the other photoelectric conversion means into an optical signal to output the optical signal to the corresponding electric apparatus, the photoelectric conversion means being disposed corresponding to the electric apparatuses, and a plurality of switch circuits for opening/closing to bypass an electric signal from the adjacent photoelectric conversion means, the switch circuits being disposed in electric signal input/output terminals of the photoelectric conversion means,
wherein the photoelectric conversion means in each of the signal relay apparatuses determines, based on a status of an optical signal from the optical transmission line, a break in the optical transmission line any of between the electric apparatuses and between the electric apparatus and the other signal relay apparatuses, and controls opening/closing of the switch circuits to stop outputting of an optical signal to the broken transmission line.

2. The optical communication system according to claim 1, further comprising:
a signal synchronizing section for synchronizing the entered electric signal with a predetermined clock component defined by the optical communication system to output the electric signal to the electric signal input terminal of the other photoelectric conversion means, the signal synchronizing section being disposed in the electric signal output terminal of each of the photoelectric conversion means.

3. The optical communication system according to claim 1,
wherein each of the photoelectric conversion means includes:
a photoelectric conversion section for generating an electric signal of a level in accordance with a level of the optical signal entered from each of the electric apparatuses;
a signal monitoring section for monitoring the level of the electric signal generated by the photoelectric conversion section to control opening/closing operation of each of the switch circuits; and
a signal processing section for amplifying and shaping, based on a monitoring result of the signal monitoring section, the electric signal generated by the photoelectric conversion section to output the electric signal to the other photoelectric conversion means.

4. The optical communication system according to claim 3,
wherein the signal monitoring section controls the opening/closing operation of each of the switch circuits after the passage of predetermined time from time at which the electric signal level becomes stable at the photoelectric conversion section.

5. The optical communication system according to claim 1,
wherein each of the signal relay apparatuses includes: a first signal relay apparatus connected through the optical transmission line to at least the electric apparatus disposed in a vehicle front portion; and a second signal relay apparatus connected through the optical transmission line to at least the first signal relay apparatus and the electric apparatus disposed in a vehicle rear portion.

6. An optical communication system comprising:
a plurality of electric apparatuses interconnected in a ring shape, each of which relays an optical signal by use of an optical transmission line; and
a plurality of signal relay apparatuses, each of which includes a plurality of photoelectric conversion means for converting an optical signal entered from each of the corresponding electric apparatuses into an electric signal to output the electric signal to another photoelectric conversion means and converting an electric signal entered from the other photoelectric conversion means into an optical signal to output the optical signal to the corresponding electric apparatus, the photoelectric conversion means being disposed corresponding to the electric apparatuses, a plurality of switch circuits for opening/closing to bypass an electric signal from the adjacent photoelectric conversion means, the switch circuits being disposed in electric signal input/output terminals of the photoelectric conversion means, and signal monitoring means for controlling opening/closing operation of each of the switch circuits,
wherein the signal monitoring means detects a variation of the electric signal outputted from the photoelectric conversion means to the switch circuit, and opens the switch circuit to allow the electric apparatus corresponding to the photoelectric conversion means to communicate with the other electric apparatus when there is a variation during over defined period.

7. The optical communication system according to claim 6,
wherein each of the switch circuits is opened in accordance with control of the signal monitoring means at the time of starting up the system, and then a break in the optical transmission line between the electric apparatus and the other signal relay apparatus is determined, based on an optical signal status from the optical transmission line, by each of the photoelectric conversion means to control opening/closing of the switch circuit.

8. A signal relay apparatus in an optical communication system in which a plurality of electric apparatuses are interconnected in a ring shape and each of the electric apparatuses relays an optical signal by use of an optical transmission line, comprising:
a plurality of photoelectric conversion means for converting an optical signal entered from each of the corresponding electric apparatuses into an electric signal to output the electric signal to other photoelectric conversion means and converting an electric signal entered from the other photoelectric conversion means into an optical signal to output the optical signal to the corresponding electric apparatus, the photoelectric conversion means being disposed corresponding to the electric apparatuses; and
a plurality of switch circuits for opening/closing to bypass an electric signal from the adjacent photoelectric conversion means, the switch circuits being disposed in electric signal input/output terminals of the photoelectric conversion means,
wherein the photoelectric conversion means controls, based on an optical signal status from the optical transmission line, opening/closing of the switch circuits to stop outputting of an optical signal to the corresponding electric apparatus.

9. The signal relay apparatus according to claim 8, further comprising:
a signal synchronizing section for synchronizing the entered electric signal with a predetermined clock component defined by the optical communication system and outputting the electric signal to the electric signal input terminal of the other photoelectric conversion means, the signal synchronizing section being disposed in the electric signal output terminal of each of the photoelectric conversion means.

10. The signal relay apparatus according to claim 8,
wherein each of the photoelectric conversion means includes:
a photoelectric conversion section for generating an electric signal of a level in accordance with a level of the optical signal entered from each of the electric apparatuses;
a signal monitoring section for monitoring the level of the electric signal generated by the photoelectric conversion section to control opening/closing operation of each of the switch circuits; and
a signal processing section for amplifying and shaping, based on a monitoring result of the signal monitoring section, the electric signal generated by the photoelectric conversion section to output the electric signal to the other photoelectric conversion means.

11. The signal relay apparatus according to claim 10,
wherein the signal monitoring section controls the opening/closing of each of the switch circuits after the passage of predetermined time from time at which the electric signal level becomes stable at the photoelectric conversion section.

12. A signal relay apparatus in an optical communication system in which a plurality of electric apparatuses are interconnected in a ring shape, and each of the electric apparatuses relays an optical signal by use of an optical transmission line, comprising:
a plurality of photoelectric conversion means for converting an optical signal entered from each of the corresponding electric apparatuses into an electric signal to output the electric signal to other photoelectric conversion means and converting an electric signal entered from the other photoelectric conversion means into an optical signal to output the optical signal to the corresponding electric apparatus, the photoelectric conversion means being disposed corresponding to the electric apparatuses;
a plurality of switch circuits for opening/closing to bypass an electric signal from the adjacent photoelectric conversion means, the switch circuits being disposed in electric signal input/output terminals of the photoelectric conversion means; and
signal monitoring means for controlling opening/closing operation of each of the switch circuits,
wherein the signal monitoring means detects a variation of the electric signal outputted from the photoelectric conversion means to the switch circuit and opens the switch circuit to allow the electric apparatus corresponding to the photoelectric conversion means to communicate with the other electric apparatus when there is a variation during over defined time.

13. The signal relay apparatus according to claim 12,
wherein each of the switch circuits is opened in accordance with the control of the signal monitoring means at the time of starting up the system, and then a break in the optical transmission line any of between the electric apparatuses and between the electric apparatus and the other signal relay apparatuses is determined, based on an optical signal status from the optical transmission line, by each of the photoelectric conversion means to control opening/closing of the switch circuit.

14. An optical communication connector in an optical communication system in which a plurality of electric apparatuses are interconnected in a ring shape, and each of the electric apparatus relays an optical signal by use of an optical transmission line, comprising:
first photoelectric conversion means for converting an optical signal entered from the optical transmission line into an electric signal to output the electric signal, and converting an entered electric signal into an optical signal to output the optical signal to the optical transmission line;
second photoelectric conversion means for converting an optical signal entered from the optical transmission line into an electric signal to output the electric signal to the first photoelectric conversion means, and converting an electric signal entered from the first photoelectric conversion means into an optical signal to output the optical signal to the optical transmission line; and
a switch circuit for bypassing the electric signal from any of the first and the second photoelectric conversion means, the switch circuit being disposed between the first and the second photoelectric conversion means,
wherein the first photoelectric conversion means controls opening/closing of each of the switch circuits based on a status of the optical signal from the optical transmission line to stop entry of the outputted electric signal to the second photoelectric conversion means, and the second photoelectric conversion means controls the opening/closing of the switch circuit based on the status of the optical signal from the optical transmission line to stop entry of the outputted electric signal to the first photoelectric conversion section.

15. The optical communication connector according to claim 14,
wherein each of the photoelectric conversion means includes:
a photoelectric conversion section for generating an electric signal of a level in accordance with a level of the optical signal entered from each of the electric apparatuses;
a signal monitoring section for monitoring the level of the electric signal generated by the photoelectric conversion section to control opening/closing operation of each of the switch circuits; and
a signal processing section for amplifying and shaping, based on a monitoring result of the signal monitoring section, the electric signal generated by the photoelectric conversion section to output the electric signal to the other photoelectric conversion means.

16. The optical communication connector according to claim 14,
wherein the signal monitoring section controls the opening/closing operation of each of the switch circuits after the passage of predetermined time from time at which the electric signal level becomes stable at the photoelectric conversion section.

17. An optical communication connector in an optical communication system in which a plurality of electric apparatuses are interconnected in a ring shape, and each of the electric apparatuses relays an optical signal by use of an optical transmission line, comprising:
first photoelectric conversion means for converting an optical signal entered from the optical transmission line into an electric signal to output the electric signal, and converting an entered electric signal into an optical signal to output the optical signal to the optical transmission line;
second photoelectric conversion means for converting an optical signal entered from the optical transmission line into an electric signal to output the electric signal to the first photoelectric conversion means, and converting an electric signal entered from the first photoelectric conversion means into an optical signal to output the optical signal to the optical transmission line;
a switch circuit for bypassing an electric signal from any of the first and second photoelectric conversion means, the switch circuit being disposed between the first and second photoelectric conversion means; and
signal monitoring means for controlling opening/closing operation of the switch circuit,
wherein the signal monitoring means detects a variation of the electric signal outputted from any of the first and second photoelectric conversion means to the switch circuit, and opens the switch circuit when there is a variation during over defined time.

18. The optical communication connector according to claim 17,
wherein the switch circuit is opened in accordance with the control of the signal monitoring means at the time of starting up the system, and then a break in the optical transmission line is determined, based on an optical signal status from the optical transmission line, by each of the photoelectric conversion means to control opening/closing of the switch circuit.
